(19) United States
(12) Patent Application Publication
(10) Pub. No.: US 2004/0167894 A1
(43) Pub. Date: Aug. 26, 2004

(54) Method for using a business model data interface

(75) Inventor: Tidhar Ziv, Hertzelia (IL)

Correspondence Address: KENYON & KENYON, 1500 K STREET, N.W., SUITE 700, WASHINGTON, DC, 20005, US

(73) Assignee: SAP AG

(21) Appl. No.: 10/630,685

(22) Filed: Jul. 31, 2003

Related U.S. Application Data
(60) Provisional application No. 60/448,466, filed on Feb. 21, 2003.

(51) Int. Cl. G06F 7/00

(52) U.S. Cl. 707/9

(57) ABSTRACT

Method and apparatus for providing a data interface application programming interface (API) to enable external data access to proprietary database systems. In accordance with one embodiment, a method for accessing data in a business database includes instantiating a company object as an instance of a company class conforming to a component object model standard, and setting a server property of the company object to a server name. The method also includes setting a company name property of the company object to the name of the business database, setting a user name property of the company object to the name of a user, setting a password property of the company object to a password of the user, and setting a language property of the company object to a desired language of the user. The method further includes invoking a connect method within the company object to open a software connection to the business database.

### FIELD OF THE INVENTION

The field of the invention relates to databases and, in particular to methods of and data interface application programming interfaces for allowing external access to the database by third-party software products.

### BACKGROUND

Directly accessing data in a database created using a proprietary software product can be a difficult, if not impossible task, if no facility has been provided by the developer of the proprietary software product to provide access to the database. This is due to the fact that a user will usually have no insight into the structure of or access mechanism for the database. Therefore, if there is no readily available data interface that the user may use to directly access the database from a customer program or a third-party add-on program, the user must create his/her own data interface. To create his/her own data interface may mean that the user has to “reverse engineer” the database structure, file names, etc. to be able to create a program or script to access the database. Unfortunately, this can lead to problems ranging from corrupting or destroying the data in the database to obtaining incorrect and/or useless data. Accordingly, it would be beneficial to provide a standardized, easy to use data interface that may be used by users of the proprietary software product and third-party developers to access the database.

### BRIEF DESCRIPTION OF THE DRAWINGS

FIG. 1 is a high-level block diagram of a computer system incorporating a functional data interface application programming interface (API) which communicates with component object model (COM) objects to interface to a host business database, in accordance with an embodiment of the present invention.

FIG. 2 is a block diagram of a general architecture for an API server 210, in accordance with an embodiment of the present invention.

FIG. 3 is a block diagram of COM objects illustrating a variety of objects that together provide an integrated functional data interface to a host business database, in accordance with an embodiment of the present invention.

FIG. 4 is a detailed diagram of the elements of the company object, in accordance with an embodiment of the present invention.

FIG. 5 is a detailed diagram of a data interface application programming interface (API) for providing data exchange with applications having incompatible user interfaces, in accordance with an embodiment of the present invention.

FIG. 6 is a block diagram of a client computer system for providing data exchange between applications having incompatible user interfaces and a database implemented to operate with a different user interface, in accordance with an embodiment of the present invention.

FIG. 7 is a flow diagram of a method for accessing a business database, in accordance with an embodiment of the present invention.

### DETAILED DESCRIPTION

Embodiments of the present invention provide an improved data interface method and software development toolkit for distributed database systems developed using proprietary software products. According to an embodiment, the method includes instantiating a company object as an instance of a company class, where the company class may conform to a component object model standard; setting a server property of the company object to a database server name; and setting a company name property of the company object to the name of a company. The method may also include setting a user name property of said company object to the name of a user; setting a password property of said company object to a password of said user; setting a language property of said company object to a desired language of said user; and invoking a connect method within said company object. The connect method may act to open a software connection to a database that may be identified by the company name property.

For example, customer-specific programs, that is, programs developed by customers to interface with the proprietary software, and/or an external third party program may use a standardized data interface API to directly access the database that was implemented using the proprietary software product. Specifically, access to the database occurs by using the data API to connect to one or more implemented component object model (COM) objects, which permit access directly to the database. COM is a standard interface for the communication of objects in distributed applications. The connection to the COM objects enables embodiments of the present invention to also provide access to all of the fields within the database. Therefore, embodiments of the present invention may provide a standard easy to implement and use data interface to directly access data stored in a database(s) using an application created using customer developed software and/or an external third party program.

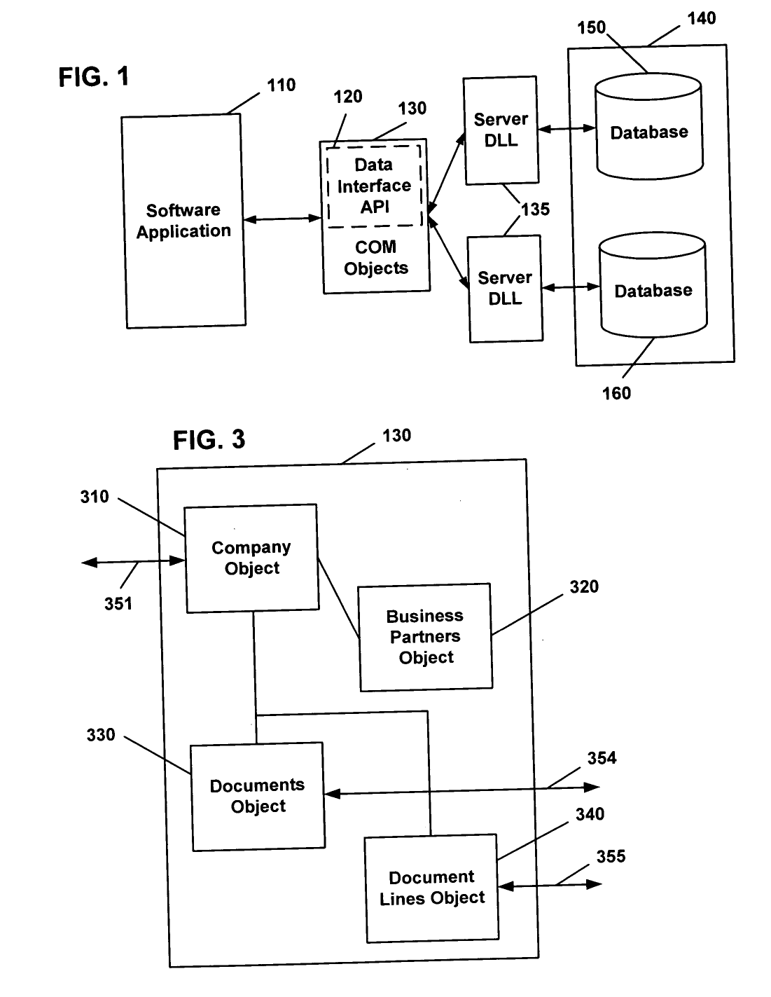

FIG. 1 is a high-level block diagram of a computer system incorporating a functional data interface application programming interface (API), which communicates with COM objects that interface to a host business database, in accordance with an embodiment of the present invention. In FIG. 1, a software application 110, for example, a third party software application, may be coupled to a data interface API 120 in a COM objects 130. Data interface API 120 may be coupled to a host computing system 140 through one or more server dynamic link libraries (DLLs) 135. For example, COM objects 130 may be coupled through server DLLs 135 to one or more business databases 150, 160 in host computing system 140.

In accordance with an embodiment of the present invention, in FIG. 1, data interface API 120 may make the internal business objects in business databases 150, 160 externally available to software application 110 for extracting and inserting data into business databases 150, 160. Data interface API 120 may support large scale data exchange so that large objects as well as a large amount of objects may be exchanged between one or both of business databases 150,160 and software application 110. A suitable mechanism to affect the data exchange may describe the business objects hierarchy and relations in a self explained manner and may include using the extensible Markup Language (XML) standard. Using XML provides the benefit of schemas for data validations and is easy to manipulate. While data interface API 120 may support XML in COM objects 130, data interface API 120 may also enhance the XML interface by allowing data manipulation via simple generic methods (not via COM objects 130) and using more structured XML, that is, the structure of the XML may be nested as the objects relations in business databases 150,160. Use of the generic methods and structured XML may make data interface API 120 more flexible and powerful to users as well as being easier to develop and maintain. Likewise, web access for business databases 150, 160 may, for example, be easily implemented via an active server page (ASP) that may wrap up the generic methods with eXtensible Stylesheet Language (XSL) and Java Scripts.

In FIG. 1, in accordance with an embodiment of the present invention, data interface API 120 may be based on COM technology. As a result, data interface API 120 may be implemented on the client side as a DLL. In multi-user embodiments, the DLL may be made available to each client by being loaded separately onto each client or, in a server environment that handles concurrent calls, the DLL may be implemented to be loaded to all clients. The server may serve as a centralized unit to handle the database connection pool as well as threads. In accordance with an embodiment of the present invention, data interface API 120 may not support re-entrant code and database connection reuse. The user, for example, may either load data interface API 120 as a DLL to their client applications or implement the server to load it. Implementing data interface API 120 from the server enables the server to handle concurrency issues like threads and database connection pools, thread safe code, synchronous and asynchronous calls and other scalability issues.

In accordance with an embodiment of the present invention, the COM automation may allow a business database's object properties to be externalized so the user may assign and use them in a simple manner with, for example, Visual Basic (VB) and/or C++. Although, the access realized by using C++ is not as “transparent” as with VB, the business objects may still be externalized via a COM automation mechanism and the user may instantiate them in the client application. In order to populate those objects with data, the user may use the assign operation for each property used. Unfortunately, this mechanism is, generally, both inefficient and tedious. For example, in a DLL configuration, it may take many method invocations and in a distributed COM (DCOM) configuration, or any other configuration that involves a server element, it may cause many inter process communication (IPC) calls. The IPC calls may be networked, since the client application, generally, runs on a separate machine. The result may be a program that produces many network calls instead of a single call in order to populate a single business object. A major advantage of the properties use may be the easy way of code writing in VB, since VB may allow a programmer to browse through the business objects and their properties and methods in a graphic way. When considering this advantage versus the disadvantage of increased method invocations, efficiency prevails.

Further, in accordance with an embodiment of the present invention, server DLL 135 may be a COM Object Bridge Server (OBS) and its method invocations may be in the same address space. Nevertheless, using COM may cause marshaling and un-marshaling of the data and return value, which may cause poor performance while using the API intensively. When upgrading the COM to DCOM in order to have a centralized server, the calls may be IPC calls, which are not only out of the client address space, but probably not on the same machine. Thus, the performance of the centralized server environment may be much worse than the distributed configuration. Another consideration involves the use of other programming and scripting languages, such as, ASP and Java. Unfortunately, although these tools do not currently benefit from the COM automation and the programmer may not browse the business objects and their methods and properties like programmers that use VB, future upgrades may enable the efficient use of these other languages. Therefore, the advantage of externalizing an object's fields via COM automation properties is, generally, VB oriented.

In accordance with an embodiment of the present invention, since XML may be used as an interface, the automation business objects may not be used for the data exchange. Instead, the user may merely exchange XML with the API via a simple interface that may include a few generic methods. Adding a new object may be similar to updating an existing one since both operations may use XML as a parameter in the same structure. For example, a generic interface's methods may include:

GetItem ([in] long UserID, [in] BSTR type, [in] BSTR xml, [out, retval] BSTR* rc);

GetList ([in] long UserID, [in] BSTR type, [in] BSTR xml, [out, retval] BSTR* rc);

Create ([in] long UserID, [in] BSTR xml, [out, retval] BSTR* rc);

Update ([in] long User)D, [in] BSTR xml, [out, retval] BSTR* rc);

Delete ([in] long UserID, [in] BSTR xml, [out, retval] BSTR* rc);

In accordance with an embodiment of the present invention, the XML structure may be passed as a parameter to all methods and the XML may be either partial or full. When the user wishes to retrieve a certain business object from the API, but does not use all fields, the API may support this feature by allowing the user to supply a partial XML string that includes empty tags of all of the fields used. In this embodiment, only the empty fields may be populated by the API and sent back to the user as a result. The partial XML mechanism may be used in the Update and Create operations as well. For example, creation of a new business object may not always need population of all fields. The user may pass to the create method a partial XML and later update the object using the update method. This method may be used with partial XML since updating an object is usually performed with only a few of the object's fields. For example, updating only the name of the business partner object may be accomplished using the following XML string:

```
<BOM>
      <BO ID=“2” Type=“Business Partner”>
            <OCRD>
                  <Header>
                        <Row>
                              <Name>John Doe</Name>
                        </Row>
                  </Header>
            </OCRD>
      </BO>
</BOM>
```

In accordance with an embodiment of the present invention, the XML hierarchy may reflect the relationships between the objects. For example, there are two major types of relations: Containment and Referencing. The first may describe a “strong” relation between objects and the second may describe loosely coupled objects. For example, the business partner objects may contain the contact person, and in this relation hierarchy, the XML may reflect the containment by nesting the contact person in the business partner object. Applications may perform operations on the business objects and their children objects. In the above nested XML structure, the operation may be much more efficient, since when extracting data from the object, the data of the children may be nested inside. However, as a result of the XML structure that exists today, the related objects may not always be nested so that sequencing and extracting of data from a business object and its children may use a search. The following is an example of a nested XML structure:

```
<BOM>
        <BO ID=“2” Type=“Business Partner”>
                <OCRD>
                        <Header>
                                <Row>
                                </Row>
                        </Header>
                        <OCPR>
                                <Header>
                                        <Row>
                                        </Row>
                                        <Row>
                                        </Row>
                                </Header>
                        </OCPR>
                </OCRD>
        </BO>
</BOM>
```

In accordance with an embodiment of the present invention, attributes in XML may be used to provide additional information about elements. In the case of data, child elements may be used, but when the element has a type, for example, business object type, it may be better to simplify the XML structure by using attributes. The example above illustrates the use of attributes in the Business Object element in order to specify the business object's ID (“2”) and Type (“Business Partner”).

In accordance with an embodiment of the present invention, when the XML structure contains a list of homogenous objects like the rows in the business objects, it may be beneficial to use an encapsulation tag that wraps up those objects. Instead of having rows as child elements of the object, the element may have a child element called Header that may contain all rows. In this way, the system may iterate more freely through the rows since they are all children of Header. Otherwise, iterating through all rows may query the element type, since the rows may not be distinguished from other children. The above XML example may describe OCPR objects that may contain two rows encapsulated by a Header.

In accordance with an embodiment of the present invention, a common tool for XML validity check is an XML schema. The purpose of the XML schema may be to define the legal building blocks of an XML document, similar to a Document Type Definition (DTD). The XML Schema may define:

elements that can appear in a document,

attributes that can appear in a document,

which elements are child elements,

the order of child elements,

the number of child elements,

whether an element is empty or can include text,

data types for elements and attributes, and

default and fixed values for elements and attributes. Therefore, the XML schema may be a map to the API business objects and users of the XML based version of the API may use the XML schemas to obtain the XML structure and the basic rules when exchanging data with the business database. Another way to obtain the XML structure may be to retrieve an empty XML from the API via a special method that the API may externalize.

In accordance with an embodiment of the present invention, in a multi-user environment, data interface API 120 may handle concurrent calls. Regardless of whether this concurrency support will be implemented in-house or by external (that is, third-party) implementers, it may be used to implement a scalable system. Data interface API 120 may communicate with the business database via server DLL 135, which may have connections management in a multi-threaded environment. The connection management may be orthogonal to the thread management and the user may have proprietary knowledge of the use of OBServer DLL 135. Therefore, the most beneficial way to handle concurrency may be to support it internally in data interface API 120. In a multi-user environment or for heavy duty tasks like migration of legacy systems to a business database, in accordance with embodiments of the present invention, a server element may be used as an API that manages threads for concurrency support.

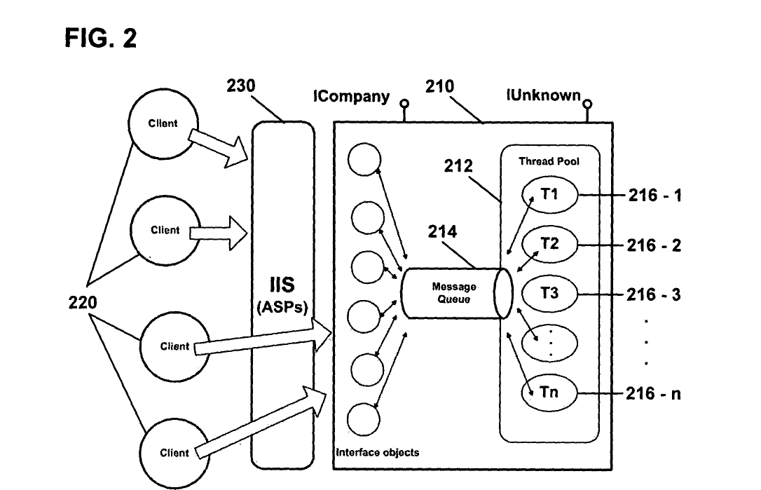

FIG. 2 is a block diagram of a general architecture for an API server 210, in accordance with an embodiment of the present invention. This architecture is based on a thread pool 212 which feeds from a single message queue 214. One or more clients 220 may communicate with API server 210 via a DCOM interface or HTTP (implemented by ASPs that may be running in the IIS or any other internet server) 230. API server 210 may handle the calls in a parallel manner by sending all requests into message queue 214. For each request in message queue 214, an available thread T1 . . . Tn 216-1, . . . , 216-n may remove the request from message queue 214 and execute it internally. For example, calling client 220 may wait for an executing thread to complete the request and, upon completion, the executing thread may signal a client thread. The communication with the business database may be done exclusively within threads T1 . . . Tn 216-1, . . . , 216-n in thread pool 212. Server DLL 135, in FIG. 1, may be loaded once in the server and a Connection Manager may handle all database connection use.

In accordance with an embodiment of the present invention, the DLL, which may be the basis for the API, may manage database connections internally and the database connections may be managed to use transactions. Since scalability equates to multi-threading and running more than a single thread usually means resource sharing, the database connection management may be externalized from the DLL to the API. Database connections may also be opened on start-up to avoid performance degradation, stored in a run-time container, and mapped by database and user. On each operation, data interface API 120 from FIG. 1 may try to acquire a connection from the run-time container (must be a thread safe resource) using the database and username. This operation may be blocked if no available connection is available. However, if the operation succeeds, the returned connection may be locked by the caller until explicitly released. In this way, the database transactions may be managed by the caller or by data interface API 120, if no transaction management is used. In order to enable external database connection management, server DLL 135 may be considered as re-entrant code and its methods may have database connection parameters on those operations within transactions.

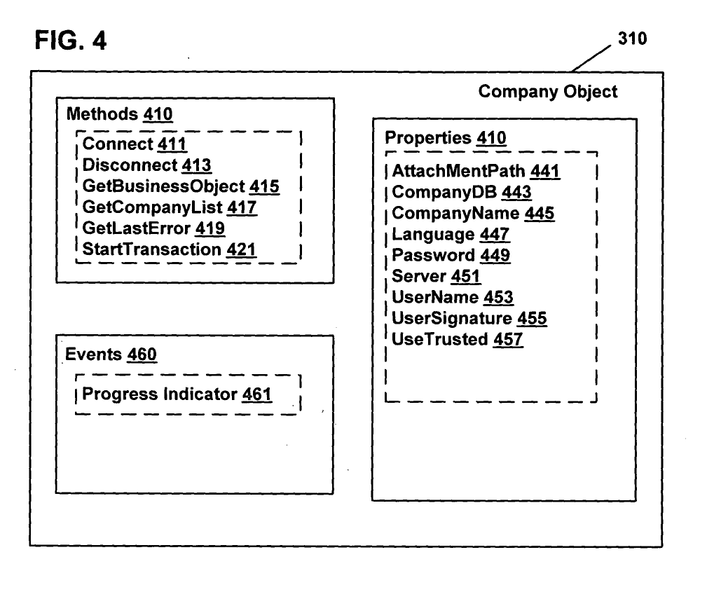

FIG. 3 is a detailed block diagram of COM objects 130 illustrating a variety of objects that together provide an integrated functional data interface to a host business database, for example, database 150 in FIG. 1, in accordance with an embodiment of the present invention. Returning now to FIG. 3, COM objects 130 may include a company object 310, a business partners object 320, a documents objects 330 and a document lines object 340.

In FIG. 3, in accordance with an embodiment of the present invention, company object 310 may represent a single company database, for example, one of business databases 150, 160, in FIG. 1, that, after being connected to, enable a user to create business objects to use to access the company database. Returning to FIG. 3, company object 310 may be the only object a user needs to create to access the company database, since all other objects may be created via company object 310. In the present embodiment, company object 310 may enable access to numerous methods and properties and an event that may provide the user with access to the company database.

In accordance with an embodiment of the present invention, in FIG. 3, documents object 230 may contain master header data for a related document that software application 110 may use to manipulate the data in at least one of business databases 150, 160 in FIG. 1. Similarly, returning to FIG. 2, document lines object 240 may represent item lines in the document identified by documents object 230, which also may permit software application 110 to manipulate the data in business databases 150, 160 in FIG. 1. For example, in FIG. 2, a request 351 from software application 110 using user interface API 120 to connect to database 150 may be received by company object 310. Although the embodiment in FIG. 3 only shows company object 310 receiving request 351 directly from software application 110, in other embodiments it may also receive request 351 via business partners object 320. In response to request 351 company object 310 may connect to documents object 330 and/or document lines object 340 to request/receive 354, 355 data from business databases 150, 160.

For example, the methods associated with company objects 310 may include those listed and described in Table 1.

TABLE 1

| Methods | Description |
|---|---|
| Connect | Connects to a Company database. |
| Disconnect | Disconnects an active connection with a |
| | company database. |
| EndTransaction | Ends a user Global transaction, which |
| | begun with a StartTransaction method. |
| GetBusinessObject | Creates a new active Business object. |
| GetBusinessObjectFromXML | Creates a new active Business object |
| | based on a valid XML file saved with |
| | the BobsCOM object. |
| GetCompanyList | Retrieves a list of companies located on |
| | the specified server. |
| GetLastError | Retrieves the last error issued by any |
| | object related to the Company object. |
| GetNewObjectCode | Retrieves the last added record key for |
| | further use with methods such as, Update. |
| GetXMLelementCount | Retrieves the number of Business objects |
| | within an XML file. |
| GetXMLobjectType | Retrieves the type of business object |
| | inside an XML file on a specific offset |
| | specified by the Index parameter. |
| StartTransaction | Starts a global transaction allowing you to |
| | perform several data operations, and then |
| | a full commit or rollback operation, |
| | based on the success or failure of one of |
| | the objects. |

For example, the properties associated with company objects 310 may include those listed and described in Table 2.

TABLE 2

| Properties | Description |
|---|---|
| AttachMentPath | Returns the path to all the company's saved mail |
| | attachments and all contact related files. |
| BitMapPath | Returns the path to all the company's saved bitmaps |
| | (picture files) related to Items, Business Partners and |
| | edited documents. |
| CompanyDB | Returns or sets the company SQL Database name. |
| CompanyName | Returns the company name, as defined in the database. |
| Connected | Returns a value specifying whether or not the |
| | ompany object is connected to the database. |
| ExcelDocsPath | Returns the path to the Company's saved excel |
| | documents exported from the application. |
| language | Returns or sets the start-up resource language of the |
| | object. |
| Password | Returns or sets the password issued to the user. |
| Server | Returns or sets the SQL Server to which the |
| | object connects. |
| UserName | Returns or sets the user id used for regular system |
| | login. |
| UserSignature | Returns the system internal user id used for internal |
| | transactions and user identification. |
| UseTrusted | Returns or sets a Boolean value specifying whether the |
| | Company object uses NT authentication to establish |
| | connection with the SQL Server, or the internal SQL |
| | Server user ObsCommon. |
| WordDocsPath | Returns the path to the company's saved Word |
| | documents exported from the application. |

For example, the events associated with company objects 310 may include those listed and described in Table 3.

TABLE 3

| Events | Description |
|---|---|
| ProgressIndicator | Occurs when a long process is being executed. |

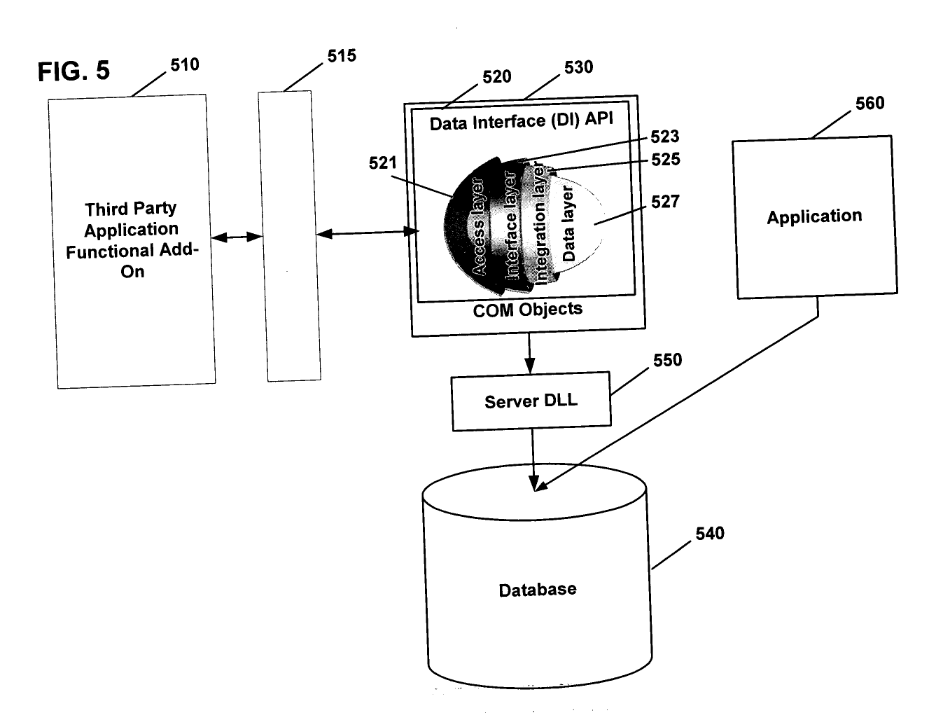

FIG. 4 is a detailed diagram of the elements of company object 310, in accordance with an embodiment of the present invention. In FIG. 4, company object 310 may include a variety of methods 410, which may be a subset of the available methods described above. For example, methods 410 may include a Connect method 411, a Disconnect method 413, a GetBusinessObject method 415, a GetCompanyList method 417, a GetLastError method 419 and a StartTransaction method 421. Company object 310 may also include a variety of properties 440, which may be a subset of the available properties described above. For example, properties 440 may include an AttachMentPath property 441, a CompanyDB property 443, a CompanyName property 445, a Language property 447, a Password property 449, a Server property 451, a UserName property 453, a UserSignature property 455, and a UseTrusted property 457. Finally, company object 310 may also include events 460, for example, a ProgressIndicator event 461. Although FIG. 4 illustrates a specific implementation of company object 310 in accordance with an embodiment of the present invention, numerous other implementations may be created using the available methods, properties and events.

FIG. 5 is a detailed diagram of a data interface application programming interface (API) for providing data exchange between applications having incompatible user interfaces and a database implemented to operate with a different user interface, in accordance with an embodiment of the present invention. In FIG. 5, a third-party application 510 having an incompatible user interface may couple to a data interface API 520 in a COM objects 530 through an access mechanism 515. Data interface API 520 may couple to a database 540 through a server DLL 550 without interaction with application 560, which was implemented using the proprietary software product to operate directly with database 540. In general, third-party application 510 may need to couple to data interface API 520 through access mechanism 515, which may include, for example, a local network, a communication network and/or a firewall for security reasons. In addition, application 560 may be coupled directly to database 540 to provide access to database 540 for internal users of application 560. Third-party application 510 does not, generally, communicate with application 560.

In FIG. 5, data interface API 520 may contain a variety of COM objects and a variety of layers. The COM objects may be referred to as business objects and the business objects may have associated with them various methods for updating, retrieving and manipulating data in business database 540. In accordance with an embodiment of the present invention, examples of some, but not all, of the classes of business objects, how they may be interfaced and a description of each object that may be included are listed and described in Table 4.

TABLE 4

| Class | Interface | Description |
|---|---|---|
| Company | ICompany | The Company object represents one company |
| | | database. After establishing a successful |
| | | connection to a company this object enables the |
| | | creation of business objects to use against the |
| | | company data source. |
| CField | IField | The Field object is used to manipulate field data. |
| | | It contains both standard and custom data |
| | | access properties. |
| Recordset | IRecordset | A Recordset object is used to run and contain |
| | | SQL data. |
| UserFields | IUserFields | The UserFields object contains a collection of |
| | | user defined data fields. |
| ContactEmployees | IContactEmployees | The ContactEmployees object represents the |
| | | contact employees connected with the Business |
| | | Partners Master Record. |
| BPAddresses | IBPAddresses | This object enables retrieving and manipulating |
| | | Business Partners addresses. |
| BusinessPartners | IBusinessPartners | The BusinessPartners object represents one |
| | | Business Partners master record, by using this |
| | | object a user may Add, Update, or Find a |
| | | Business Partner record. |
| Document_Lines | IDocument_Lines | The Document_Lines object represents an item |
| | | lines in Sales and Purchase documents. |
| Documents | IDocuments | The Documents object represents a Sales and |
| | | Purchase document header. It contains the |
| | | master header data for the document such as |
| | | Card code, and Address. |
| Items_Prices | IItems_Prices | This object is used to describe prices under |
| | | different price lists. |
| Items | IItems | The Items object represents a Master Inventory |
| | | items record, It enables a user to Add, Update or |
| | | Find an Item object record. |
| JournalEntries_Lines | IJournalEntries_Lines | This object represents Journal Entry lines that |
| | | are connected to the journal entries object. |
| JournalEntries | IJournalEntries | Represents one Journal Entry in the Company |
| | | database. |
| Recipients | IRecipients | This object is used to describe recipients' |
| | | information in a Message. |
| Messages | IMessages | Expose an interface that enables send |
| | | messages to the application. |
| Bob | IBob | The Bob object is an accessory that enables a |
| | | user to obtain valuable information quickly and |
| | | easily. The returned data is usually a Recordset |
| | | object for convenience of data manipulation. |
| Payments_Checks | IPayments_Checks | Payments through checks. |
| Payments_Invoices | IPayments_Invoices | The invoices that the payments work for. |
| Payments_CreditCards | IPayments_CreditCards | Payments through credit cards. |
| Payments_Accounts | IPayments_Accounts | Payments through account transfer. |
| Payments | IPayments | The Payment object is used to handle banking |
| | | related procedures, a user may use this object to |
| | | handle the incoming payments from customers, |
| | | and payment methods can be cash, credit cards, |
| | | checks, or bank transfer. |
| ProductTrees_Lines | IProductTrees_Lines | The ProductTrees_Lines object represents the |
| | | system Sales and Purchase Documents item |
| | | lines. |
| ProductTrees | IProductTrees | Enables manipulating and managing a product |
| | | tree. |
| StockTransfer_Lines | IStockTransfer_Lines | This object represents detailed information |
| | | occurred in Stock Transfer, each line contains |
| | | information about how items are transferred from |
| | | one warehouse to the other. |
| StockTransfer | IStockTransfer | This object is used to transfer items from one |
| | | warehouse to the other. |
| Contacts | IContacts | The Contacts object represents a system |
| | | contacts with the Business Partners object. |
| StockTaking | IStockTaking | This object is used to take items from a |
| | | warehouse, or to put items into a warehouse. |
| SpecialPrices | ISpecialPrices | This object is used to manage the special price |
| | | list you created for a customer, or a supplier |
| | | created for you. |
| Currencies | ICurrencies | Enables managing currencies. |
| ChartOfAccounts | IChartOfAccounts | Controls the G/L accounts. |
| WorkOrder_Lines | IWorkOrder_Lines | A collection of work order lines. |
| WorkOrders | IWorkOrders | Enables manipulating work orders for |
| | | production/ |
| AlternateCatNum | IAlternateCatNum | Enables define alternative catalog numbers for |
| | | suppliers. |
| Attachment | IAttachment | The Attachment object represents one item of |
| | | the Attachments object, in the system. One |
| | | Attachment object is represented by a file. |
| Attachments | IAttachments | The Attachments collection holds Attachment |
| | | files information. It is used in objects like |
| | | Contacts and Messages. |

In FIG. 5, the layers in data interface API 520 may include an access layer 521, an interface layer 523, an integration layer 525 and a data layer 527. Access layer 521 may provide the functionality to access business database 540 and deal with security, version control, permissions and the like. Interface layer 523 may provide the simple COM interface to the business objects in business database 530. Integration layer 525, which may include DI COM 530 and server DLL 550, may deal with the integration of the two. Data layer 527, which may generally be located in server DLL 550, may contain the business logic behind the objects plus the methods and function calls to retrieve data from business database 540.

In FIG. 5, in accordance with an embodiment of the present invention, data interface API 520 may be implemented in a software development kit (SDK) that enables external clients to access company databases, such as business database 540. The SDK may include data interface API 520 having multiple COM objects and methods, and a company object for accessing the business database being one of the multiple COM objects, such that the company object may be accessible by external development tools to access the plurality of COM objects and methods.

In accordance with an embodiment of the present invention, the SDK may be used to program a data interface connection between the external client and a company database, for example, third party application 510 and business database 540, respectively. Specifically, the SDK may be used to implement a logon procedure by instantiating an instance of a company object, for example company object 310 of FIG. 3, to access business database 540 of FIG. 5. Company object 310 may, generally, be the highest object in the object-hierarchy that may be used to access the company database and may, for example, be an instance of the class BobsCOM.Company. To logon to the company database the client program may initially create company object 310 using, for example, the commands Public vCmp as BobsCOM.Company and Set vCmp = New BobsCOM.Company. After company object 310 is created, Server property 451, UserName property 453, Password property 449, Language property 447 and CompanyDB property 443 of company object 310 may be set as the connection parameters. For example, the properties may be set using the following commands:

| | |
|---|---|
| vCmp.Server = “My_DB_Server” | ‘Name of the MSSQL DB |
| | Server; |
| vCmp.CompanyDB = “My_Company” | ‘Put in the company name |

vCmp.UserName = “dagobert”
vCmp.Password = “secret”
vCmp.language = BobsCOM.In_English

Similarly, server property 451 may be set to the name of the database server and CompanyDB 443 may be set to the name of the company whose database will be used. Likewise, UserName property 453, Password property 449 and Language property 447 may contain the name of the user, the user's password and the language to be used for the session to be opened, respectively. To connect to the company database Connect method 411 of the company object 310 may be called using, for example:

Dim I as Long

I=vCmp Connect( ).

To disconnect from database 530 Disconnect method 413 of company object 310 may be called using, for example:

vCmp.Disconnect( ).

In accordance with embodiments of the present invention, in FIG. 5, once the user is connected to database 540, data may be accessed using business objects that exist within COM objects 130. To create a business object and obtain a reference to it, one of the company object methods, for example, GetBusinessObject 415 or GetBusinessObjectFromXML (from Table 1) may be used. For example, GetBusinessObject 415 may be used to create a new empty business object and set the properties of the object so that business data can be retrieved or manipulated. For example, commands that refer to the BusinessPartners object (from Table 4) may include:

‘Declare a suitable reference variable:

Dim vBP As BobsCOM.BusinessPartners

‘Get a new business partners object

Set vBP=vCmp.GetBusinessObject(oBusinessPartners).

Similarly, in accordance with embodiments of the present invention, GetBusinessObjectFromXML may be used to create a new business object with predefined properties from an XML file. In general, the structure of the XML file may be the same as if the concrete business object is saved using a SaveXML method. The business objects may each have methods for creating (for example, Add), changing (for example, Update), deleting (for example, Remove) or reading a special data object of the GetByKey kind. For example, creating a new customer database 530 may include:

Dim ret As Long
Dim errmsg As String
BpCardCode as Strng
vBP.CardCode = “C00003”
vBP.CardName = “Ronald G. Tailor
vBP.CardType = “C”

| | |
|---|---|
| ret - vBP.Add( ) | ‘ ret = 0 if and only |
| | if Add( ) was successful |
| vCmp.GetNewObjectCode bpCardCode | ‘ This shows the key of |
| | the last modified |
| | ‘ object. GetNewObjectCode is |
| | a standard |
| | ‘ method of the company object |

```
if ret Then
    vCmp.GetLastError ret, errmsg
    msgbox errmsg
End If
```

Likewise, an example of reading the data of a special customer with a dedicated key may include:

```
Dim bpCardCode as String, _{—}
      bpCardName as String, _{—}
      bpCardType as String
If vBP.GetbyKey(“C00003”) = True Then
      bpCardCode = vBP.CardCode
      bpCardName = vBP.CardName
      bpCardType = vBP.CardType
Else
      Msgbox “No matching customer record was found!!!”
End If
```

In accordance with embodiments of the present invention, the business data within a company database may, generally, be accessed via the predefined business objects in the SDK. Accessing the business data via the predefined business objects permits authorization checks to be performed by the business objects and any data access using the business objects is platform-independent and release compatible. For example, any external client program that accesses data exclusively using the predefined business objects does not need to be adapted if the company database is upgraded to a higher release or support package level.

For example, in accordance with an embodiment of the present invention, when a data operation is performed on a business object, a transaction may be started. If the operation is successful, then a Commit may be issued and the data may be saved. If the operation fails, then a Rollback may be issued and the data may be discarded. As long as only one business object is to be modified, this kind of transaction handling may be sufficient. However, if the need to perform a consistent transaction that contains the changes of more than one business object exists, the begin and the end of the transaction may be specified, for example, using the company object methods StartTransaction( ) and EndTransaction(endType as BobsCom.BoWffransOpt) from Table 1.

Further, in accordance with an embodiment of the present invention, the StartTransaction method may start a “global” transaction, which may contain any kind of changes of several business objects. If StartTransaction is called, all Business objects changes, which are issued behind this call and before a following call of the method EndTransaction, may belong to one logical unit of work. If one of the business object changes fails during any process, the transaction may end and a rollback may be issued. In case of a success, EndTransaction may be used to do the commit, to dequeue the locked records and to allow other users to access to them.

The EndTransaction method may be used to mark the end of a global transaction opened by StartTransaction, in accordance with an embodiment of the present invention. In contrast to StartTransaction, a parameter, which describes whether the changes contained within this transaction should be committed or rolled back, may be passed to the EndTransaction method as in the following example:

EndTransaction(endType as BobsCOM.boWfTransOpt)

Possible values of endType:

BobsCOM.wf_ Commit: Transaction should be committed

BobsCOM.wf_ Rollback: All changes contained in the transaction should be discarded.

In accordance with an embodiment of the present invention, it may be possible to define additional fields for the business data categories. These fields may be called user-defined fields and they may not be affected by any release or support package level upgrade. It may be possible to access the contents of user-defined fields using the UserFields object from Table 4. In contrast to business objects, this object cannot be created with the GetBusinessObject method. However, all business objects that can have user-defined fields have a UserFields property. This property may be read-only and may contain a reference to a UserFields object, which may grant access to contents of the user-defined fields for that business object. For example, to access the user-defined fields for a given business partner, the preconditions may include:

VBP, which may have been already defined as a reference variable of type BobsCOM.BusinessPartners and points to an existing object)

TxtValue, which may be a Textbox-Control defined at design time

LblName, which may be a Label-Control defined at design time

```
Dim oUserFields as BobsCOM.UserFields, _{—}
    ii as integer
Dim oFields as BobsCOM.Fields
Dim oField as BobsCOM.Field
Set oUserFields = vBP.UserFields
Set oFields = oUserFields.Fields
For each oField in oFields
    If ii > 0 Then
      AddUF
    End If
    TxtValue(ii) = oField.Value
    LblName(ii).Caption = oField.Name
    ii = ii + 1
Next oField
Sub AddUF
  ‘ Adds a new label and a new textbox control to the actual form
  Dim newnum As Long
  newnum = LblName.Count
  Load LblName(newnum)
  Load TxtValue(newnum)
  LblName(newnum).Left = LblName(newnum − 1).Left
  TxtValue(newnum).Left = TxtValue(newnum − 1).Left
  LblName(newnum).Top = LblName(newnum − 1).Top + _{—}
    LblName(newnum − 1).Height + 5
  TxtValue(newnum).Top = TxtValue(newnum − 1 ).Top + _{—}
    TxtValue(newnum − 1).Height + 5
End Sub
```

The BobsCOM.UserFields object may have a Fields property, which points to a BobsCOMFields object. This object may be a collection of several BobsCOM.Field objects.

In accordance with an embodiment of the present invention, if an error occurrs in the SDK, company object method GetLastError (errCode as Long, errMsg as String) from Table 1 may be called to obtain the return code and its description. The method may be called immediately after the error occurred. If there are calls of other methods between, this may result in a loss of error information. If no error occurred, errCode may contain the value 0 and errMsg may be an empty string. Otherwise errCode may contain a value different from 0 and errMsg may contain the error description.

In accordance with an embodiment of the present invention, to close the data interface connection to the company database, the Disconnect( ) method of the company object may be called to close the session.

In accordance with an embodiment of the present invention, there may exist situations where the desired business data either may not be reached via the business object or the user may want to get lists of business objects. In such a situation two special objects may be used: the Recordset object and the Bob object from Table 4.

In accordance with an embodiment of the present invention, the RecordSet-Object from Table 4 may be a special object for a generic access to existing database tables of the company database. Actually its method DoQuery may run any valid SQL command against the database. This fact has some consequences that must be considered and kept in mind, including:

1) Database tables may be accessed directly;

2) Arbitrary Inserts, Updates and Deletes may be done without authorization and business logic checks; and

3) Structure of database tables may change during release or supportpackage level upgrade => It may be necessary that coding of client programs using the recordset object becomes invalid after a release or support package level upgrade of the system.

Possible application scenarios may be at first an access to database tables not belonging to the system standard, because no corresponding business objects exist. Second the Bob object may contain several methods for data accesses that may not be possible when using the standard business objects. These methods, generally, always return a Recordset object.

In accordance with an embodiment of the present invention, the RecordSet object may contain a result set which may consist of one or more identical rows. The object may have special methods for processing the data contained in the result set, for example:

MoveFirst: Moves to the first row of the result set

MoveLast: Moves to the last row of the result set

MoveNext: Moves to the next row of the result set

MovePrevious: Moves to the previous row of the result set

SaveXML: Writes the result set with XML format into an ASCII file

Additionally there may be some important properties for processing the result data including, for example:

Bof: Returns a boolean value. If true, the actual row is the first row

Eof: Returns a boolean value. If true, the actual row is the last row

Fields: This property returns a BobsCOM.Fields object for accessing dedicate columns of a row

RecordCount: Returns the number of columns of the result set as a long value

In accordance with an embodiment of the present invention, the Bob object may be an accessory that enables the user to obtain information from the company database in a manner that may not be supported by the ordinary business objects like BusinessPartners, Documents, and StockTaking etc.). Its methods for obtaining access to the business data return a Recordset Object, because in most cases these methods may select several data records of identical structure. For example, the method GetBPList may retrieve a list of defined business partners in the company, and the method GetUserList may retrieve a list of users defined in the company.

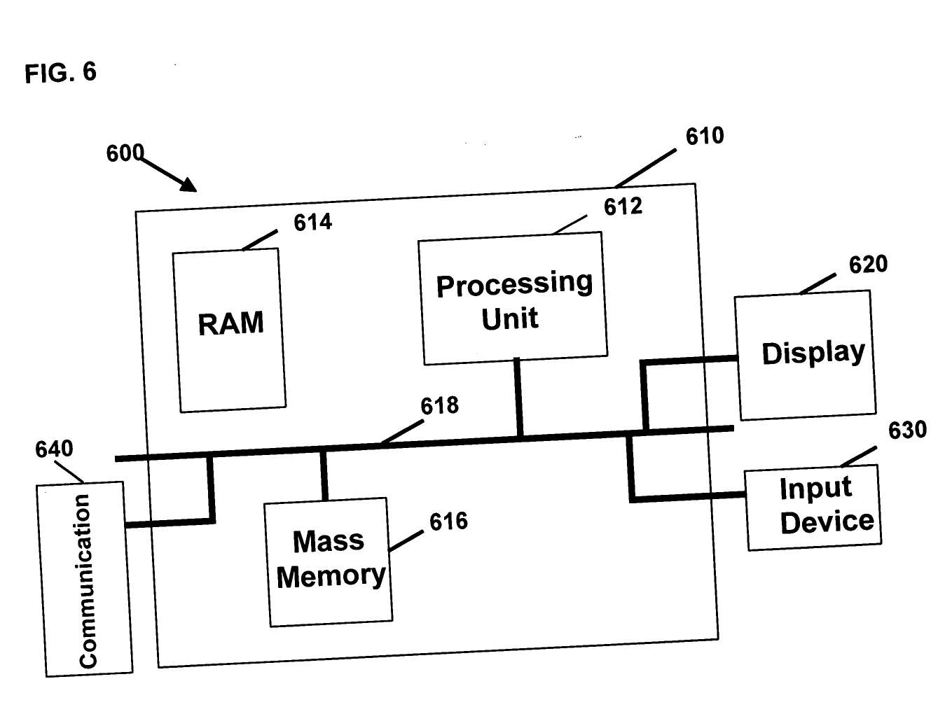

FIG. 6 is a block diagram of a client computer system for providing data exchange between applications having incompatible user interfaces and a database implemented to operate with a different user interface, in accordance with an embodiment of the present invention. In FIG. 6, a client computer system 600 includes a processing component 610 coupled to a display component 620, an input component 630 and a communication component 640. Processing component 610 may include a central processing unit 612, a random access memory (RAM) 614 and a mass memory system 616 coupled together via a main system bus 618. Mass memory system 618 may include, for example, an operating system, a browser program, a database data access component and an application for accessing an incompatible database. In fact, in embodiments of the present invention, the operating system may include Microsoft® Windows® 98 second edition, Windows® 2000 sp1 or higher, Windows® XP® or Windows® NT® with sp5 or higher. The browser program may, for example, include Microsoft® Internet Explorer 5.5 or higher. The database data access component may, for example, include Microsoft® data access component v2.5 (mdac_typ.exe). The application accessing the incompatible database may, for example, include a software development kit such as SAPBobsCom.dII.

In FIG. 6, display component 620 may be capable of displaying 24-bit colors and may include, for example, a standard CRT, a liquid crystal display, and a flat panel display. Input component 630 may include, for example, a keyboard, a writing tablet, and a voice-to-text. Communication component 640 may include, for example, a dial-up modem, a digital cable modem, a direct network connection, and a wireless modem.

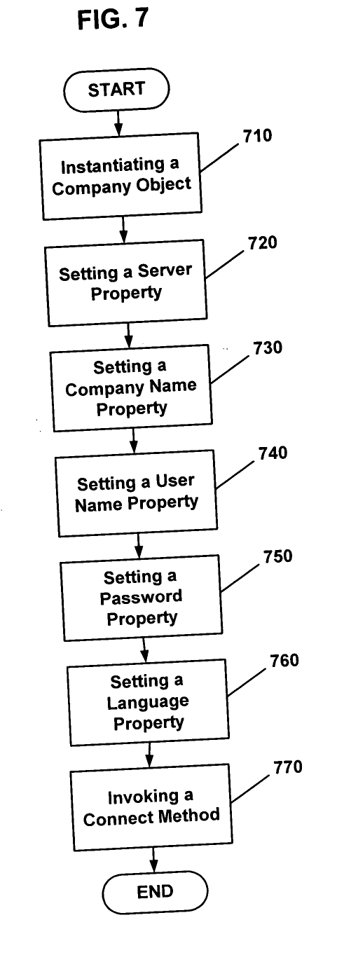

FIG. 7 is a flow diagram method for accessing a business database, in accordance with an embodiment of the present invention. In FIG. 7, the method may include software application 110 instantiating (710) company object 310 as an instance of a company class conforming to a component object model standard in business database 150 and setting (720) a server property of company object 310 to a database server name. The method may also include setting (730) a company database name property of company object 310 to the name of a company, setting (740) a user name property of company object 310 to the name of a user, setting (750) a password property of company object 310 to a password of the user, and setting (760) a language property of company object 310 to a desired language of the user. The method may further include invoking (770) a connect method within company object 310, to open a software connection to business database 150, which may be identified by the company database name property.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for accessing data in a server-based business database system using an external program, the method comprising:
instantiating a company object as an instance of a company class conforming to a component object model standard to access data in a server-based business database system;
setting a server property of said company object to a server name containing said business database;
setting a company name property of said company object to the name of said business database;
setting a user name property of said company object to the name of a user;
setting a password property of said company object to a password of said user;
setting a language property of said company object to a desired language of said user; and
invoking a connect method within said company object, said connect method opening a software connection to said business database.

2. The method of claim 1 wherein said setting a server property of said company object to a server name comprises setting said server property to an input server name.

3. The method of claim 1 wherein said setting a server property of said company object to a server name comprises setting said server property to a default server name from the company object, if the server property is not set.

4. The method of claim 1 wherein said invoking a connect method within said company object, said connect method opening a software connection to a desired company database comprises connecting an external data warehouse management system to said business database.

5. The method of claim 1 further comprising accessing said business database using business objects from said company object.

6. The method of claim 5 wherein said business objects expose a plurality of methods for accessing said business database.

7. The method of claim 5 wherein said accessing said business database using said business objects comprises updating said business database.

8. The method of claim 5 wherein said accessing said business database using said business objects comprises retrieving data from said business database.

9. The method of claim 5 wherein said accessing said business database using said business objects comprises manipulating data from said business database.

10. The method of claim 1, further comprising:
invoking a disconnect method within said company object to close said software connection to said desired company database.

11. A machine-readable medium having stored thereon a plurality of executable instructions to perform a method for accessing a server-based business database system comprising:
instantiating a company object as an instance of a company class conforming to a component object model standard to access data in a server-based business database system;
setting a server property of said company object to a server name containing said business database;
setting a company name property of said company object to the name of said business database;
setting a user name property of said company object to the name of a user;
setting a password property of said company object to a desired password;
setting a language property of said company object to a desired language; and
invoking a connect method within said company object, said connect method opening a software connection to said business database.

12. The machine-readable medium of claim 1 wherein setting a server property of said company object to a server name comprises setting said server property to an input server name.

13. The machine-readable medium of claim 1 wherein setting a server property of said company object to a server name comprises setting said server property to a default server name from the company object, if the server property is not set.

14. The machine-readable medium of claim 1 wherein said invoking a connect method within said company object, said connect method opening a software connection to a desired company database comprises connecting an external data warehouse management system to said business database.

15. The machine-readable medium of claim 1 further comprising accessing said business database using business objects from said company object.

16. The machine-readable medium of claim 5 wherein said business objects expose a plurality of methods for accessing said business database.

17. The machine-readable medium of claim 5 wherein said accessing said business database using said business objects comprises updating said business database.

18. The machine-readable medium of claim 5 wherein said accessing said business database using said business objects comprises retrieving data from said business database.

19. The machine-readable medium of claim 5 wherein said accessing said business database using said business objects comprises manipulating data from said business database.

20. The machine-readable medium of claim 1 further comprising:
invoking a disconnect method within said company object to close said software connection to said desired company database.

21. A software development kit for providing a data interface to access a business database comprising:
an application programming interface including a plurality of component object model objects and methods; and
a company object for accessing said business database being one of said plurality of component object model objects, said company object being accessible by external development tools to access said plurality of component object model objects and methods.

22. The software development kit of claim 21 wherein said company object comprises:
a plurality of properties including:
a server property;
a username property;
a password property;
a language property; and
a company database property.

23. The software development kit of claim 22 wherein said server property comprises:
a name of a database server.

24. The software development kit of claim 22 wherein said username property comprises:
a name of an authorized user.

25. The software development kit of claim 25 wherein said password property comprises:
a password for said authorized user.

26. The software development kit of claim 25 wherein said language property comprises:
a language to be used for said authorized user.

27. The software development kit of claim 22 wherein said company database property comprises:
a name of a company having access to said business database.

28. A machine-readable medium having stored thereon a plurality of executable instructions comprising:
a software development kit for providing a data interface to access a business database, said software development kit including:
an application programming interface including a plurality of component object model objects and methods; and
a company object for accessing said business database being one of said plurality of component object model objects, said company object being accessible by external development tools to access said plurality of component object model objects and methods.

29. The machine-readable medium of claim 28 wherein said company object comprises:
a plurality of properties including:
a server property;
a username property;
a password property;
a language property; and
a company database property.

30. The machine-readable medium of claim 29 wherein said server property comprises:
a name of a database server.

31. The machine-readable medium of claim 29 wherein said usemame property comprises:
a name of an authorized user.

32. The machine-readable medium of claim 31 wherein said password property comprises:
a password for said authorized user.

33. The machine-readable medium of claim 31 wherein said language property comprises:
a language to be used for said authorized user.

34. The machine-readable medium of claim 29 wherein said company database property comprises:
a name of a company having access to said business database.

35. A data processing system comprising:
means for instantiating a company object as an instance of a company class conforming to a component object model standard to access data in a business database;
means for setting a server property of said company object to a server name containing said business database;
means for setting a company property of said company object to the name of said business database;
means for setting a user name property of said company object to the name of a user;
means for setting a password property of said company object to a desired password;
means for setting a language property of said company object to a desired language; and
means for invoking a connect method within said company object, said connect method opening a software connection to said business database.

36. The data processing system of claim 35 further comprising:
means for accessing said business database using business objects from said company object.

37. The data processing system of claim 36 wherein said business objects expose a plurality of methods for accessing said business database.

38. The data processing system of claim 36 wherein said accessing said business database using said business objects comprises updating said business database.

39. The data processing system of claim 36 wherein said accessing said business database using said business objects comprises retrieving data from said business database.

40. The data processing system of claim 36 wherein said accessing said business database using said business objects comprises manipulating data from said business database.

41. The data processing system of claim 35 wherein said method further comprises:
invoking a disconnect method within said company object to close said software connection to said desired company database.

42. A computer system comprising:
a processing component;
a communication component coupled to said processing component;
a display component coupled to said processing component; and
an input device coupled to said processing component;
said processing component including a machine-readable medium having stored thereon a plurality of executable instructions to perform a method including:
instantiating a company object as an instance of a company class conforming to a component object model standard to access data in a business database;
setting a server property of said company object to a server name containing said business database;
setting a company name property of said company object to the name said business database;
setting a user name property of said company object to the name of a user;
setting a password property of said company object to a desired password;
setting a language property of said company object to a desired language; and
invoking a connect method within said company object, said connect method opening a software connection to said business database.

43. The computer system of claim 42 wherein said processing component comprises:
a processing unit; and
a bus coupled to said processing unit, said communication component, said display component and said input device component.

44. The computer system of claim 43 wherein said processing component further comprises:
a random access memory coupled to said processing unit via said bus.

45. The computer system of claim 44 wherein said processing component further comprises:
a mass memory system coupled to said processing unit via said bus.
